(19) United States
(12) Patent Application Publication
(10) Pub. No.: US 2002/0029236 A1
(43) Pub. Date: Mar. 7, 2002

(54) Method and apparatus for processing scientific posters

(76) Inventors: Frank Burgel, Scarsdale, NY (US); Mark C. Salamon, Bayside, NY (US)

Correspondence Address: NIXON & VANDERHYE P.C., 8th Floor, 1100 North Glebe Road, Arlington, VA, 22201, US

(21) Appl. No.: 09/933,868

(22) Filed: Aug. 22, 2001

Related U.S. Application Data
(60) Provisional application No. 60/226,669, filed on Aug. 22, 2000.
(60) Provisional application No. 60/270,633, filed on Feb. 23, 2001.

(51) Int. Cl. G06F 17/00

(52) U.S. Cl. 709/1; 345/700

(57) ABSTRACT

A system for processing scientific posters over a global network enables users to generate professionally-prepared posters conveniently and at reasonable costs. The system enables a user to select design parameters for the poster, and after establishing design criteria and uploading substantive data to be included in the poster, the scientific poster is generated for user review and subsequent delivery. Delivery can be effected via one or more vehicles according to user preference. Electronic poster components facilitate display, archiving, cross-referencing and dissemination of scientific posters and enable the incorporation of more detailed drill-down data access or links to helpful supplementary information. The data uploaded from the user for processing the scientific posters may be stored by searchable database categories, such as author(s), subject matter, conference, date, etc. In this manner, the electronic poster in either its basic format or in drill-down and/or dynamic format allows for “virtual” poster sessions, wherein E-posters can be searched on a poster by poster basis according to one or more of the database categories.

### CROSS-REFERENCES TO RELATED APPLICATIONS

This application claims the benefit of U.S. Provisional Patent Applications Serial No. 60/226,669, filed Aug. 22, 2000, and Ser. No. 60/270,633, filed Feb. 23, 2001, the entire contents of which are herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates to the processing of scientific posters and, more particularly, to a method and computer system for processing scientific posters over a global network by incorporating user-selected design parameters and user-input substantive data.

The scientific publication process typically includes four distinct stages. In the first stage, an abstract or brief summary (usually 250 words or less) of a study is submitted for peer review to a scientific conference. The abstract is either accepted or rejected by the peer review process. Accepted abstracts are often published in special editions of conference journals and may be made available on CD-ROMs or a conference's website. In a second stage, about 80% of the abstracts that are accepted allow the author to create a poster, which further documents the study. The posters, which will be described in detail below, are typically only available for viewing for a short period of time (usually 1-4 hours) during the actual conference. Posters are not generally made available on either CD-ROM or the conference's website. In addition, the poster is typically not reproduced (after the completion of the poster session) in any printed format. In a third stage, a relatively small percentage of accepted abstracts are turned into oral presentations at a conference. These presentations are usually supported by visual media such as photographic and/or PowerPoint (or other similar software) slides.

Finally, in a fourth stage, after months or even years later, an abstract may be fleshed out into a full article and again submitted to the peer review process. This time, the peer review is managed by the scientific journal. If accepted, the article will be published in a scientific journal or the like and possibly be made available on CD-ROM or online.

In this process, the first stage is primarily controlled by the conference or college, and the fourth stage is primarily controlled by a publisher, which often is part of the conference/association/college. Both of these groups assume responsibility for content and eventually disseminate the information either electronically or in print media or both. The second stage (posters) is the sole responsibility of the author(s). The authors are responsible for poster content, creation and presentation.

A scientific poster is a distinct and unique presentation form found almost exclusively in the scientific community. Posters describe the results of a scientific study and, traditionally, are created for public display at a conference or other meeting. Such posters are typically generated either by hand or by using off-the-shelf software such as the Microsoft Office Suite. The size of a poster is often dictated by the conference and based on the amount of space allotted to each presenter. Posters may vary from postcard size up to 7′×4′ or larger.

In order to describe their study, most poster authors include information that would fall under the following or similar headers: Abstract, Title, Author(s), Introduction, Purpose, Methods, Results, Conclusions and Implications. Information found under these headers is described through the use of text, graphics, charts, spreadsheets, drawings, photos, electron-micrographs and other relevant object types.

As stated above, an abstract, or a synopsis of a study, is first submitted to a professional conference, college, or association for peer review. The peer review process either accepts the abstract or rejects it. If accepted, many abstracts are turned into posters for public display at poster presentations. The conference will specify, often in great detail, various poster requirements, which may include but not be limited to overall poster size, font size, font type, elements of content, colors, number of images, etc. During a conference or meeting, a large room is made available where posters are displayed and where the poster authors are allowed to discuss their study and answer any questions during an allotted time period. The total amount of time that a poster is available for viewing is typically less than eight hours with question and answer time limited to an hour or less.

Poster quality is highly variable due to an author's access to appropriate software, software skill level, design skill, printer quality and availability of large format printers for larger posters. Because of this, some authors turn to professional graphic designers and commercial printers for their poster production needs. Professionally generated posters, however, are expensive and time consuming to create.

### BRIEF SUMMARY OF THE INVENTION

It would thus be desirable to provide a website that is specifically designed to facilitate the production of scientific posters, thereby providing a more efficient and cost effective process for poster generation and production. The process according to the invention incorporates a software supported user interface for processing scientific posters over the Internet.

The software enables a user to input user-selected design parameters for the scientific poster. These parameters may include poster size, orientation, figure placement, resolution, paper type, colors and the like. After establishing design criteria and uploading the substantive data to be included in the poster, the user's scientific poster is generated for reviewing and subsequent delivery. Delivery can be effected via one or more vehicles according to user preference.

Browser-based Internet use presents new opportunities for the production, display, archiving, cross-referencing and dissemination of scientific posters. While all scientific posters will continue to describe a study or experiment, several distinct poster products according to the present invention serve to meet current and future scientific needs. A physical poster is a hard copy printout suitable for conference presentation. Such a poster is the professionally prepared version of the traditional scientific poster. An electronic poster (or E-poster) is effected via one or more web pages that can be viewed using a standard Internet browser. Depending on the user's wishes, E-posters may have embedded hyperlinks that lead to supplementary information. A “drill-down” poster may include comprehensive and multi-faceted access to the study. Additionally, a dynamic poster may store audio and video recordings of the study or related activities.

In an exemplary embodiment of the present invention, a method of processing scientific posters over a global network includes the steps of (a) enabling a user to input user-selected design parameters for a scientific poster; (b) generating a sample poster according to the user-selected design parameters and confirming the user-selected design parameters; (c) uploading user-input substantive data; (d) building an image of the scientific poster according to the user-selected design parameters and the user-input substantive data; and (e) delivering the scientific poster according to a desired delivery process. Step (a) is preferably practiced by enabling the user to input user-selected design parameters including at least one of poster size, orientation, figure placement, resolution, paper type, colors and the like. In this context, step (a) is practiced by enabling the user to select a poster size from a plurality of predetermined poster sizes or enabling the user to input a custom poster size. The design parameters may be input by providing access to a poster gallery including a plurality of poster samples and enabling the user to select one of the poster samples.

The method may further include, between steps (d) and (e), the step of providing the image of the scientific poster to the user for review and effecting any necessary edits according to the user's review. In this context, a plurality of users may have selective access to the poster image in a collaborative virtual laboratory, wherein editing is performed according to an instruction from any of the plurality of users with selective access. Step (e) may be practiced by printing the scientific poster image and shipping the printed image to the user. Alternatively, step (e) may be practiced by posting the scientific poster image on an internet web page. In this context, the internet web page may require password or ID access. Additionally, hyperlinks may be incorporated in the web page that lead to supplementary information.

In one embodiment, step (a) is practiced by enabling the user to input drill-down components of the scientific poster, wherein step (c) is practiced by uploading drill-down component data from the user, and wherein step (d) is practiced by incorporating the drill-down components into the scientific poster image and enabling access to the drill-down components through the image. In addition or alternatively, step (a) may be further practiced by enabling the user to input dynamic components of the scientific poster, wherein step (c) is practiced by uploading dynamic component data from the user, and wherein step (d) is practiced by incorporating the dynamic components into the scientific poster image and enabling access to the dynamic components through the image. The dynamic components may include audio, visual, audio/visual recordings, and the like relating to the subject of the scientific poster.

The method may still further include the step of storing data for processing the scientific poster according to searchable database categories, including, for example, author, subject matter, conference, date, etc. The user-input substantive data may also be stored in a dedicated vault, wherein the user is provided user-only access to the user's dedicated vault. In this context, step (d) may be practiced by linking designated files from the user's dedicated vault, wherein when one or more of the designated files is modified, step (d) includes updating the scientific poster image according to the modified files.

In another exemplary embodiment of the invention, a method of processing scientific posters over a global network includes the steps of (a) enabling users to create scientific posters according to user-selected design parameters and user-input substantive data; (b) producing the scientific posters according to user-selected production methods; (c) archiving the scientific posters and cross-referencing related scientific posters; and (d) enabling access to the scientific posters via the global network.

In yet another exemplary embodiment, a computer system is provided for processing scientific posters. The computer system includes at least one user computer running a computer program that effects input information relating to user-selected design parameters for a scientific poster and substantive data for the scientific poster. The computer system also includes a system server running a server program, wherein the at least one user computer and the system server being interconnected by a computer network. The system server receives the input information and builds an image of the scientific poster according to the user-selected design parameters and the user-input substantive data, and the server delivers the scientific poster according to a desired delivery process.

In still another exemplary embodiment of the invention a computer program is embodied on a computer-readable medium for processing scientific posters over a global network.

### BRIEF DESCRIPTION OF THE DRAWINGS

These and other aspects and advantages of the present invention will be described in detail with reference to the accompanying drawings, in which:

FIG. 1 is a schematic illustration of a computer system;

FIG. 2 is a broad illustration of the home system according to the present invention; and

FIG. 3 illustrates exemplary components of the invention for processing scientific posters.

### DETAILED DESCRIPTION OF PREFERRED EMBODIMENTS

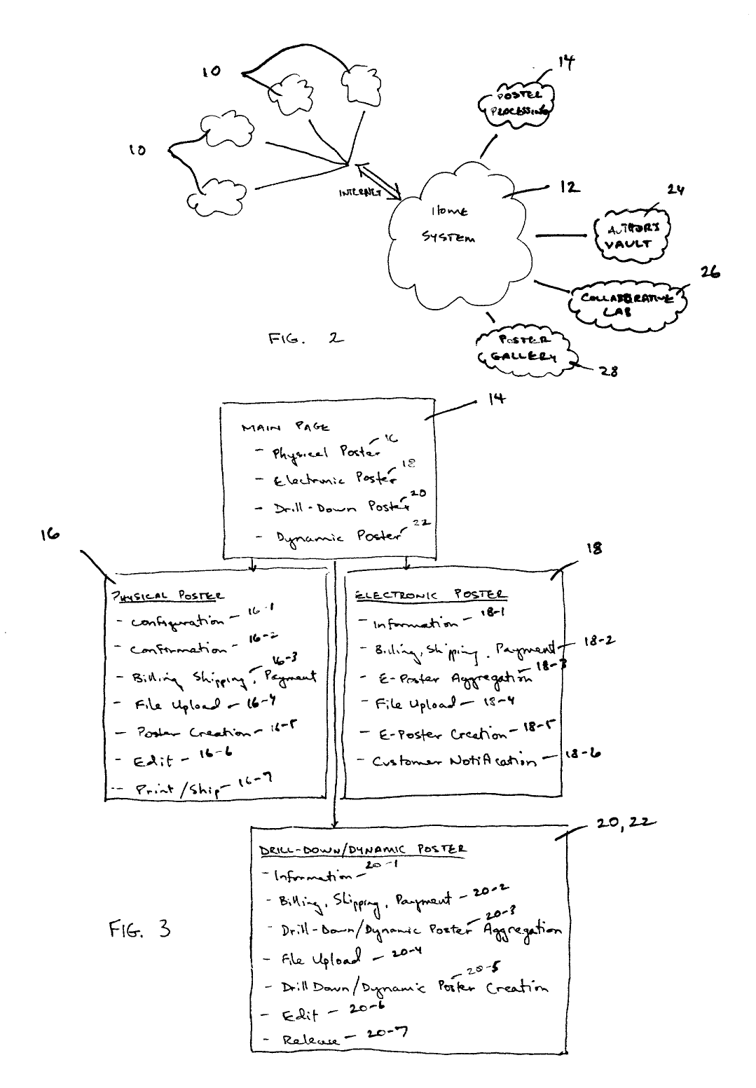

The scientific poster processing system implemented in the diagrams of FIGS. 2 and 3 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:

the transfer protocol (e.g., http://); and

the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java^{™} enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the scientific poster processing system of the present invention include Netscape^{®} Navigator available from Netscape^{®} Communications Corporation and Internet Explorer available from Microsoft^{®} Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the scientific poster processing system described below and illustrated in the accompanying drawings.

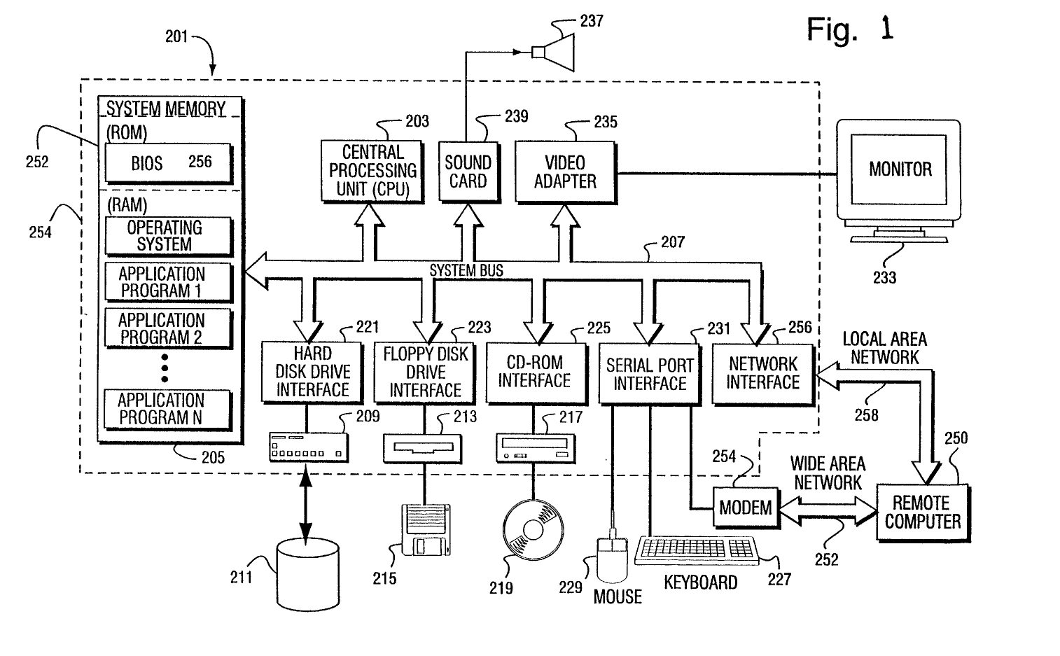

FIG. 1 generally illustrates a computer system 201 suitable for use as the client and server components of the scientific poster processing system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem 254 or other means for establishing communications over the wide area network 252, such as the Internet. The modem 254, which may be internal or external, is connected to the system bus 207 via the serial port interface 231. A network interface 256 may also be provided for allowing the computer system 201 to communicate with a remote computing device 250 via a local area network 258 (or such communication may be via the wide area network 252 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

This browser-based Internet use serves as an excellent vehicle with the system according to the present invention to present new opportunities for the production, display, archiving, cross-referencing and dissemination of scientific posters. With reference to FIG. 2, multiple users 10 can access the system 12 according to the present invention via the Internet to significantly expand scientific poster production and use in the scientific publication process.

While all scientific posters will continue to describe a study or experiment, the system according to the present invention defines several distinct poster products to meet current and future scientific needs. The home system 12 can be provided with many access and use components, including, for example, the poster production system component as discussed in detail below, a poster access component including provisions for searching, ordering, referencing scientific posters archived within the system. Additionally, the home system 12 could include information about publication in general, the use of posters and poster production in general, information about scientific conferences including dates and locations, etc. A poster gallery 28 contains poster samples for general perusal or for providing users for basic elements of their poster. The home system 12 will include links for additional valuable components of the system mentioned above, which are described in more detail below.

From the main scientific poster processing page 14, users can select what type of poster they intend to process. A physical poster 16 is a hard copy printout suitable for conference presentation. The physical poster is the professionally prepared version of the traditional scientific poster. An electronic poster (E-poster) 18 includes one or more web pages that can be viewed using a standard Internet browser. Depending on the user's wishes, E-posters may have embedded hyperlinks that lead to supplementary information. Examples of supplementary information include the author's curriculum vitae, descriptions of similar studies, related or subsequent full-text online articles, links to discussion forums regarding the particular study, etc. A drill-down poster 20 includes one or more web pages that provide comprehensive and multi-faceted access to the study. This poster allows the viewer to “drill down” into the study in order to review and analyze detailed raw data. A dynamic poster 22 includes an electronic poster that stores audio, video and audio/video recordings of the study or related activities. For example, a study to determine a particular drug's efficacy might show a video, such as a dynamic graph, chart, animation, etc., of the patient's critical test parameters before, during and after dosing or a surgical procedure would be available in video format. All relevant numerical results could also be available and could be directly linked to the procedure or dosing, etc. It is possible to view these tests from any point in time in order to view reactions over time. Animation and dynamic charts and graphs can also be viewed using a sliding time bar. Both still and video images of MRI's, X-rays, ultrasounds and other supporting evidence can be integrated. Finally, the author may include documentation including audio/video commentary describing the author's approach and methodology so others could review the author's conclusions. The dynamic poster 22 can also incorporate drill-down information, i.e., the poster can be both drill-down as well as dynamic.

Upon the selection of physical poster processing 16, the author or user is presented with a physical poster configuration page 16-1. Here the user selects the various elements of the poster configuration including, but not limited to, poster size, orientation, figure placement, resolution, paper type, colors, etc. With respect to poster size, the system includes a plurality of predetermined poster sizes (e.g., twenty poster sizes) that cover most users‘ needs. Alternatively, the user can input any custom size that may be required. With respect to figure placement, the user may select where on the poster their images should appear. Images may be interspersed throughout the text, centered, aligned across the top, aligned across the bottom, right aligned, left aligned, etc. Standard resolution is 600×600 dots per inch, although other choices are available at the user's option. Preferably, for the physical poster 16, a heavy weight 35 lb. coated paper is used. Users are provided with an option to upgrade to glossy paper or the like. With respect to colors, users can choose from among a number of different colors. The user may also select design parameters by accessing the poster gallery 28. Templates may also be uploaded into the poster gallery 28 for repeated use by multiple scientists at the same company or the like to accommodate any company poster requirements (e.g., company logo, etc.). Of course, other user-selected design parameters for the scientific poster can be incorporated, and the invention is not necessarily meant to be limited to the described exemplary design parameters.

After the user makes choices from the configuration page 16-1, a sample poster based on those choices is presented. The sample poster effects a confirmation page 16-2 that will be portrait or landscape in orientation, have figures placed as specified and display in the colors chosen. This sample provides the user with a clear idea of what the final poster will look like. Below the sample may appear an itemized listing of the user's choices along with associated costs (if any).

Billing, shipping and payment information 16-3 can then be collected as needed.

Next, the file upload process 16-4 allows the user to identify individual files that comprise the poster on the user's computer (via floppy disk, hard drive, CD-ROM, DVD, etc.) and upload them to the system server. The system can assist the user in organizing their files in such a way as to facilitate poster creation. For example, a specific file created in a word processing program can be defined as a specific poster element (e.g., “Title,” “Result,” etc.). Other software products used to make charts, graphic images, designs, etc. can also be specifically designated for placement in the poster. One way of accomplishing this is to create virtual bins under each header and the user drag and drop the files to the appropriate bins. The web server programming make all necessary database entries and alert the graphics component to the new transaction. Using the uploaded files, system personnel including graphic artists build an image of the physical poster in the poster creation process 16-5 using a known page layout program such as Quark or PageMaker, typically in PDF format. The file is then carefully compared against the original uploaded files for errors or problems. An electronic image of the physical poster is sent to the user for approval or edit 16-6. If an edit is required, another image is sent to the user for approval once the edit is complete. Finally, when the electronic image is approved by the user, the physical poster is printed and shipped 16-7.

In the electronic poster process, the author is presented with an E-poster information page 18-1, where the user is provided with the costs and requirements for processing the E-poster. Billing, shipping and payment information 18-2 are collected as needed. In an E-poster aggregation process 18-3, the user is prompted to describe the user's files in terms of how they “come together” to form a poster. In this context, the user may compose this description in a text box that has been especially designed for this purpose. The description can include text that specifies which files contain the various sections of the poster (i.e., Introduction, Results, etc.). The description may also indicate a desired sequence of poster images, links, and the like. In this manner, as discussed above, the system assists the user in organizing files for uploading to the server. Any special user requirements are also entered here. In the file upload process 18-4, the user identifies the individual files that comprise the poster on the user's computer, and the files are uploaded to the system server. The server programming make all necessary database entries and alert a graphics component to the new transaction. Using the user's uploaded files, the E-poster is created 18-5, typically in HTML format, but could also be provided in PDF format, or both. Hyperlinks may be included that lead to supplemental information and may include, among other items, the ability to click on an author's name to access the author's curriculum vitae, which may open the author's bibliography and/or picture. From the bibliography, there may be still additional links to the author's place of business, etc. Other links may lead to discussion forums, the original abstract, or full-text online articles resulting in a seamless information chain. All information in an E-poster may be fully indexed and made available for online searching and viewing.

Subsequently, the user is notified 18-6 via E-mail or the like that their E-poster is available for viewing. The user is also supplied with the E-poster ID number, which can be provided to others to provide outside access to the poster.

In the drill-down/dynamic poster process 20, 22, the user is presented with a drill-down and/or dynamic poster information page 20-1, where the user is provided with the cost and requirements for processing a drill-down/dynamic poster. Billing, shipping and payment information 20-2 are collected as needed. Because of the complexity and size of some of the files, special care is taken to ensure that the system server completely understands where the “drill-down” areas on the poster are and exactly which files are used 20-3. The user is asked to describe the data files in terms of how they “come together” to form a poster, e.g., via the text box discussed above. The same applies for dynamic elements. Any special user requirements are also entered here. In the file upload process 20-4, the system prompts the user to identify the individual files that comprise the poster data, and the files are uploaded to the system server. The server programming make all necessary database entries and alert the graphics component to the new transaction. Using the user's uploaded files, system personnel design and build the drill-down and/or dynamic poster 20-5. In addition to the underlying data, the drill-down and/or dynamic posters may be able to show movement. That is, the posters can be provided with access to video of actual experiments, graphs that build and change as the study progresses, raw data with the ability to stop the study at any point in time to examine anomalies or other points of interest, and supporting animation. Additional possibilities include audio files, underlying graphs or images, additional or more detailed textual explanations, etc. Videos, audio components and numerical results from outside sources such as medical devices or procedures may also be available. Audio and video presentations regarding the study can also be linked to the posters. These posters thus not only allow the entire study to be recreated in a virtual manner, but will also contain supporting information that led to the particular result and conclusion.

The user is alerted that the poster is available for approval or edit via E-mail or the like 20-6, and a final version is not released until user approval is received. Once received, the drill-down and/or dynamic poster is released 20-7 via the home system 12 for general review.

In each of the product categories, the user can choose from standard processing time or request a “rush” job for an additional fee. All electronic images may be made available for view by entering the poster ID number in “view poster” areas of the website 12. The data uploaded from the user for processing the scientific posters is preferably stored by searchable database categories, such as author(s), subject matter, conference, date, etc. In this manner, the E-poster in either its basic format or in drill-down and/or dynamic format allows for “virtual” poster sessions, wherein E-posters can be searched on a poster by poster basis according to one or more of the database categories.

An author's vault 24 is a secure area that only the author has access to. Security to this area is based on login name and password. The amount of space available to an individual may or may not be limited. While a scientist could store anything he wants in the author's vault, it may be structured so that all the files required for posters would reside there. This will allow the author to update his work and have that update immediately reflected on the home site without any server input. If necessary, special software may be provided for organizing and validating these files. For example, the system would have to be aware if linked files were deleted, moved or otherwise disrupted.

In a secure collaborative virtual lab 26, two or more scientists can collaborate on a project by providing a secure area to store data and other files and where software can be used for data analysis. Each member of the group will be able to view and work on the data as they desire. A communications package may be used to allow the group members to communicate and maintain an audit trail of their communications. In addition, instant messaging and audio and video conferencing may be provided for the group also. A user may create a private and secure area where carefully chosen colleague could view, discuss and actually work on ideas, experiments, data, results, implications, methodologies, etc. In other words, the collaborative lab provides a highly secure and private collaborative component dedicated to scientific research.

As discussed earlier, one of the steps in scientific publishing is oral presentations. Oral presentations are given at conferences to audiences of various sizes and usually include supporting slides and/or other visual and audio media. Currently, these presentations may be available on audio tape. The system according to the invention will provide virtual presentations that include not only audio and visual components of the speaker but also all supporting material that pertains to the talk. Raw data, slides and other relevant images, charts and graphs, related works by other authors, bibliographies, alternative positions and a means for communicating with the speaker are also provided.

The system will maintain a current database of scientific conferences along with their dates, locations, contact people, phone numbers, poster requirements and other relevant information. At least two different methods will be available to search the system database. The first method is to search by conference name. However, conference names can be quite long and complex and may include styles and words that are prone to typing and search errors such as roman numerals, convoluted medical terminology and foreign language terms. In order to quickly find even the most obscurely named conference, the system allows the database to be searched by date of conference, country, state (province or equivalent) and city in that order. Entering the date will produce a listing of all conferences being held during that time period. Each time a new search criteria (country, state, city) is entered, it will further narrow the listed group. In using this search mechanism, a unique match will be located quickly and easily.

Various portions of the website may be segmented to facilitate use by specific groups of customers. For example, the types of poster samples a meteorologist will want to review will be distinct from those samples a hematologist will want to see. In order to satisfy these customer requirements, categories of scientific specialties may be created for the poster gallery as well as other areas where such segmentation would be helpful.

With the system according to the present invention, scientific authors and other interested users can create professionally-prepared posters conveniently and at reasonable costs. The E-poster components facilitate display, archiving, cross-referencing and dissemination of scientific posters and enable the incorporation of more detailed drill-down data access or links to helpful supplementary information.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of processing scientific posters over a global network, the method comprising:
(a) enabling a user to input user-selected design parameters for a scientific poster;
(b) generating a sample poster according to the user-selected design parameters and confirming the user-selected design parameters;
(c) uploading user-input substantive data;
(d) building an image of the scientific poster according to the user-selected design parameters and the user-input substantive data; and
(e) delivering the scientific poster according to a desired delivery process.

2. A method according to claim 1, wherein step (a) is practiced by enabling the user to input user-selected design parameters including at least one of poster size, orientation, figure placement, resolution, paper type, and colors.

3. A method according to claim 2, wherein step (a) is practiced by enabling the user to select a poster size from a plurality of predetermined poster sizes or enabling the user to input a custom poster size.

4. A method according to claim 1, wherein step (a) is practiced by providing access to a poster gallery including a plurality of poster samples and enabling the user to input poster design parameters by selecting one of the poster samples.

5. A method according to claim 1, further comprising, between steps (d) and (e), the step of providing the image of the scientific poster to the user for review and effecting any necessary edits according to the user's review.

6. A method according to claim 1, further comprising storing the user-input substantive data in a dedicated vault and providing user-only access to the user's dedicated vault.

7. A method according to claim 6, wherein step (d) is practiced by linking designated files from the user's dedicated vault.

8. A method according to claim 7, wherein when one or more of the designated files is modified, step (d) comprises updating the scientific poster image according to the modified files.

9. A method according to claim 1, wherein step (e) is practiced by printing the scientific poster image and shipping the printed image to the user.

10. A method according to claim 1, wherein step (e) is practiced by posting the scientific poster image on an internet web page.

11. A method according to claim 10, further comprising enabling password or ID access to the internet web page.

12. A method according to claim 10, wherein step (e) is practiced by incorporating hyperlinks in the web page that lead to supplementary information.

13. A method according to claim 1, wherein step (a) is practiced by enabling the user to input drill-down components of the scientific poster, wherein step (c) is practiced by uploading drill-down component data from the user, and wherein step (d) is practiced by incorporating the drill-down components into the scientific poster image and enabling access to the drill-down components through the image.

14. A method according to claim 13, wherein step (a) is practiced by enabling the user to input dynamic components of the scientific poster, wherein step (c) is practiced by uploading dynamic component data from the user, and wherein step (d) is practiced by incorporating the dynamic components into the scientific poster image and enabling access to the dynamic components through the image.

15. A method according to claim 1, wherein step (a) is practiced by enabling the user to input dynamic components of the scientific poster, wherein step (c) is practiced by uploading dynamic component data from the user, and wherein step (d) is practiced by incorporating the dynamic components into the scientific poster image and enabling access to the dynamic components through the image.

16. A method according to claim 15, wherein the dynamic components comprise audio, visual or audio/visual recordings relating to a subject of the scientific poster.

17. A method according to claim 1, further comprising storing data for processing the scientific poster according to searchable database categories.

18. A method according to claim 17, wherein the searchable database categories comprise at least one of author, subject matter, conference, and date.

19. A method according to claim 1, further comprising, after step (d), the step of editing the scientific poster image according to user instructions.

20. A method according to claim 19, further comprising enabling selective access by a plurality of users to the scientific poster image in a collaborative virtual laboratory, wherein the editing step is performed according to an instruction from any of the plurality of users with selective access.

21. A method of processing scientific posters over a global network, the method comprising:
(a) enabling users to create scientific posters according to user-selected design parameters and user-input substantive data;
(b) producing the scientific posters according to user-selected production methods;
(c) archiving the scientific posters and cross-referencing related scientific posters; and
(d) enabling access to the scientific posters via the global network.

22. A method according to claim 21, wherein step (c) is practiced by storing data for processing the scientific posters according to searchable database categories.

23. A method according to claim 22, wherein the searchable database categories comprise at least one of author, subject matter, conference, and date.

24. A method according to claim 21, further comprising, after step (b), the step of (e) delivering the scientific posters according to a desired delivery process.

25. A method according to claim 24, wherein step (e) is practiced by posting the scientific posters on an internet web page.

26. A method according to claim 25, further comprising enabling password or ID access to the internet web page.

27. A method according to claim 25, wherein step (e) is practiced by incorporating hyperlinks in the web page that lead to supplementary information.

28. A computer system for processing scientific posters, the computer system comprising:
at least one user computer running a computer program that effects input information relating to user-selected design parameters for a scientific poster and substantive data for the scientific poster; and
a system server running a server program, the at least one user computer and the system server being interconnected by a computer network, the system server receiving the input information and building an image of the scientific poster according to the user-selected design parameters and the user-input substantive data, the server delivering the scientific poster according to a desired delivery process.

29. A computer program embodied on a computer-readable medium for processing scientific posters over a global network, the computer program comprising:
means for enabling a user to input user-selected design parameters for a scientific poster;
means for generating a sample poster according to the user-selected design parameters and confirming the user-selected design parameters;
means for uploading user-input substantive data;
means for building an image of the scientific poster according to the user-selected design parameters and the user-input substantive data; and
means for delivering the scientific poster according to a desired delivery process.
